(19) United States
(12) Patent Application Publication
(10) Pub. No.: US 2002/0007633 A1
(43) Pub. Date: Jan. 24, 2002

(54) Hydrostatic continuously variable transmission

(76) Inventors: Mitsuru Saito, Saitama (JP); Yoshihiro Yoshida, Saitama (JP); Kazuhiro Takeuchi, Saitama (JP); Yasushi Fujimoto, Saitama (JP)

Correspondence Address: BIRCH STEWART KOLASCH & BIRCH, PO BOX 747, FALLS CHURCH, VA, 22040-0747, US

(21) Appl. No.: 09/867,390

(22) Filed: May 31, 2001

(30) Foreign Application Priority Data
May 31, 2000 (JP) 2000-161926

(51) Int. Cl. F16D 31/02

(52) U.S. Cl. 60/489

(57) ABSTRACT

The object of the present invention is to simplify a structure for supporting a distributor valve and to reduce the weight thereof in a hydrostatic continuously variable transmission. A U-shaped clip is placed into a groove made on the head portion of a distributor valve and the distributor valve is passed in this state through the elongated hole of an expansion ring and the clip ring is engaged with the expansion ring whereas the inner peripheral surface of a slip ring is engaged with the head portion of the distributor valve.

### BACKGROUND OF THE INVENTION

1. Field of the Invention

The present invention relates to a hydrostatic continuously variable transmission having a distributor valve in which a holding structure is simplified.

2. Description of Background Art

A hydrostatic continuously variable transmission has been known as a continuously variable transmission for a motorcycle or an automobile. Such a continuously variable transmission is disclosed in Japanese Examined Patent Publication No. 7-56340 and Japanese Unexamined Patent Publication No. 4-203553. Its schematic configuration is illustrated in FIG. 8.

As shown in FIG. 8, this hydrostatic continuously variable transmission has a fixed displacement type swash plate hydraulic pump P connected to the crank shaft side of an engine and a variable displacement type swash plate hydraulic motor M connected to a speed reduction gear side. The hydraulic pump P and the hydraulic motor M are connected to each other to constitute a hydraulic closed circuit via an inside oil passage (low pressure passage) 52 which is a low pressure passage in a normal load operation but is a high pressure passage in a speed reducing operation, that is, in a reverse load operation and an outside oil passage (high pressure passage) 53 which is a high pressure passage in a normal load operation but is a low pressure passage in a reverse load operation. An oil supply passage 47 connected to an oil supply pump 88 sucking oil from an oil reservoir 87 is connected to the inside oil passage 52 via a first check valve 95 and is connected to the outside oil passage 53 via the second check valve 96.

The hydraulic pump P and the hydraulic motor M both include cylinder bores formed in the same circumference and plungers (pistons) reciprocating in the cylinder bores. Valve bores for connecting the cylinder bores to the low pressure oil passage and the high pressure oil passage are radially positioned and distributor valves are mounted into the respective valve bores and are reciprocated in a radial direction to switch the cylinder bores between the high pressure oil passage and the low pressure oil passage.

The distributor valves of the hydraulic pump side are driven by a first eccentric ring to which power is transmitted from a driving side and the distributor valves of the hydraulic motor side are driven by a second eccentric ring of a casing side. A slip ring (or ball bearing) is disposed inside each eccentric ring and the tops of the distributor valves are in sliding contact with the inside of the slip ring. The distributor valves of the hydraulic pump side and the hydraulic motor side are combined with respective expansion rings at their top sides.

The conventional combination structure of the distributor valves with the expansion ring is disclosed in Japanese Examined Patent Publication No. 6-89831. In this structure, an expansion ring includes a plurality of elongated holes having two holes of different diameters as compared to the number of distributor valves and the top of each distributor valve is passed through the hole of a large diameter and is shifted to the hole of a small diameter and then the hole of a large diameter side is closed with a plug. Further, in another structure the top of each distributor valve is enlarged and sandwiched by the expansion ring and the slip ring.

The conventional structure described in the former, however, complicates the shape of the hole of the expansion ring and hence increases manufacturing costs. Further, it needs a plug for clogging the hole. Still further, in the conventional structure, the distributor valve regulates the motion of the expansion ring and hence the plug collides with the distributor valve to apply an impact load to the plug. In this case, it is thought that an iron-base material having resistance to an impact is used as the material of the plug but the iron-base material increases the weight of the plug, which results in an increase in the inertia mass of the expansion ring and a decrease in the action thereof. In the structure described in the latter, if the top of the distributor valve, whose peripheral surface is finished by grinding, is enlarged in size, the distributor valve can not be through-ground, which makes it difficult to ensure accuracy and increases manufacturing costs.

### SUMMARY AND OBJECTS OF THE INVENTION

In view of such circumstances, the present invention has been made and it is an object of the present invention is to provide a simple combination structure of distributor valves with an expansion ring which can reduce weight and costs.

A hydrostatic continuously variable transmission includes a hydraulic closed circuit in which a swash plate hydraulic pump is connected to a swash plate hydraulic motor with a low pressure oil passage and a high pressure oil passage concentric with the low pressure oil passage. The swash plate hydraulic pump includes valve bores each of which is radially formed to connect the cylinder bore of the hydraulic pump to the low pressure oil passage and the high pressure oil passage. The swash plate hydraulic motor includes valve bores each of which is radially positioned to connect the cylinder bore of the hydraulic motor to the low pressure oil passage and the high pressure oil passage. Distributor valves are provided and are disposed in individual valve bores and are moved in a radial direction to switch the cylinder bore of the hydraulic pump and the cylinder bore of the hydraulic motor between the low pressure oil passage and the high pressure oil passage and are combined with an expansion ring. The configuration of the present invention to solve the problem described above is characterized in that the head portion of the distributor valve is inserted into an elongated hole made in the expansion ring and that a clip is engaged with a groove made on the head portion of the distributor valve projecting outside from the expansion ring to combine the distributor valve with the expansion ring.

According to the hydrostatic continuously variable transmission having the above-mentioned configuration, the distributor valve is supported with the expansion ring only by putting the clip in the groove of the head portion of the distributor valve and by passing the distributor valve in this state through a simple elongated hole made in the expansion hole. Hence, this can simplify the structure thereof and reduce the weight thereof.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a longitudinal cross-sectional view of a hydrostatic continuously variable transmission in accordance with one preferred embodiment in which the present invention is applied to the power unit of a vehicle;

FIG. 2 is a side view, partly in cross section, of a first or a second expansion ring;

FIG. 3 is a plan view of an expansion ring;

FIG. 4 is a plan view of a U-shaped clip;

FIG. 5 is a side view of a U-shaped clip;

FIG. 6 is a side view of a distributor valve;

FIG. 7 is an enlarged view of a switching portion of a distributor valve; and

FIG. 8 is a schematic configurational view of a hydrostatic continuously variable transmission.

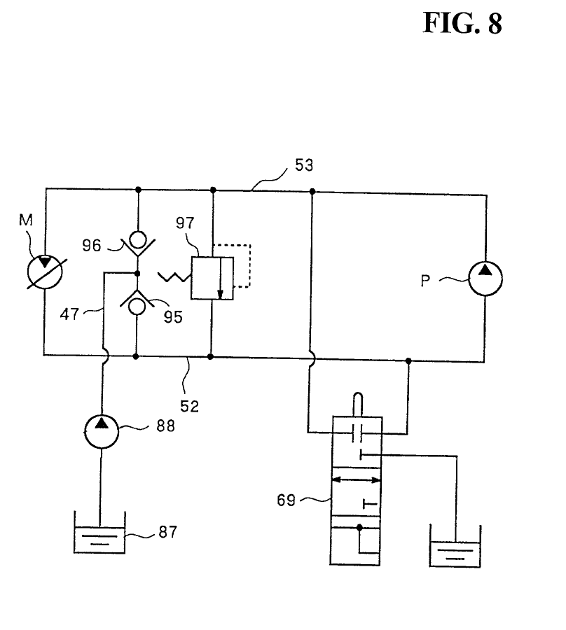

### DETAILED DESCRIPTION OF THE PREFERRED EMBODIMENTS

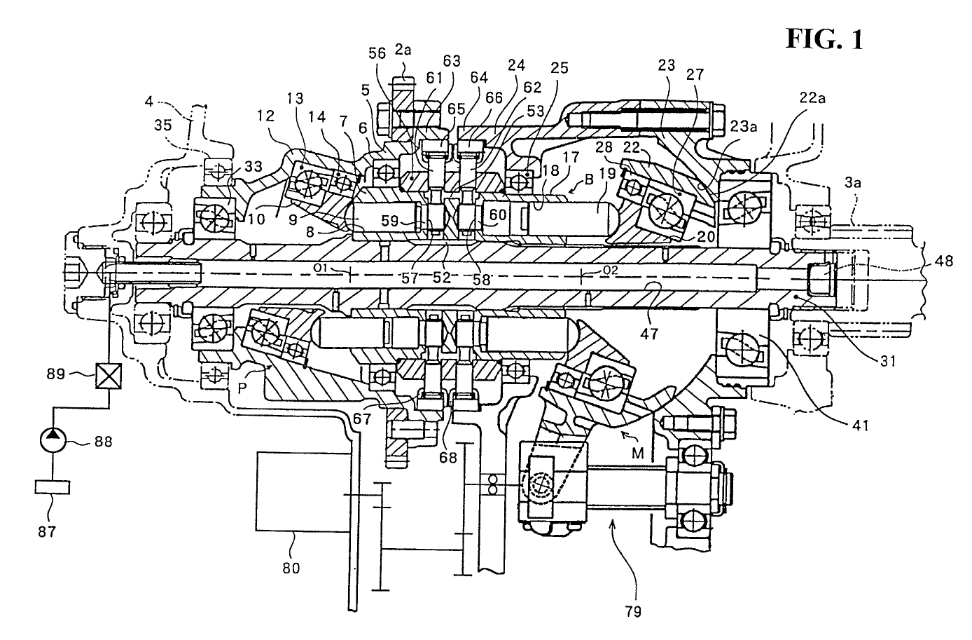

In FIG. 1, there is illustrated a longitudinal cross-sectional view of a hydrostatic continuously variable transmission in accordance with one preferred embodiment in which the present invention is applied to the power unit of a vehicle.

In FIG. 1, a swash plate hydraulic pump P includes an input cylindrical shaft 5 provided with an output gear 2a of a first speed reduction gear; a pump cylinder 7 relatively rotatably supported by the inside peripheral wall of the input cylindrical shaft 5 via a ball bearing 6; a plurality of cylinder bores 8 formed in the pump cylinder 7 in an annular arrangement such that they surround the rotary axis of the pump cylinder 7; a plurality of pump plungers 9 slidably fitted in the respective cylinder bores 8; a plate 10 whose front surface is engaged with and put into contact with the outside ends of the respective pump plungers 9; and a pump swash plate 12 for supporting the plate 10 via an angular contact bearing 13 and a radial bearing 14 so as to hold the plate 10 in a state tilted at a predetermined angle with respect to the axis of the pump cylinder 7 around an imaginary trunnion axis O1 intersecting the axis of the pump cylinder 7 at right angles. The pump swash plate 12 is integrally formed with the input cylindrical shaft 5.

When the input cylindrical shaft 5 is rotated, the pump swash plate 12 described above reciprocates the pump plungers 9 via the plate 10 and the bearings 13, 14 to make them repeat a suction stroke and a discharge stroke.

The hydraulic motor M includes a motor cylinder 17 integrally formed with the pump cylinder 7 described above and positioned at the right side in FIG. 1 on the same axis as the pump cylinder 7; a plurality of cylinder bores 18 formed in the motor cylinder 17 such that they surround the rotary axis of the motor cylinder 17; a plurality of motor plungers 19 slidably fitted in the respective cylinder bores 18; a plate 20 whose front surface is engaged with and put into contact with the outside ends of the respective pump plungers 19; a motor swash plate 22 for supporting the plate 20 via an angular contact bearing 27 and a radial bearing 28; and a motor swash plate anchor 23 for supporting the back surface of the motor swash plate 22.

The opposed contact surfaces 22a and 23a of the motor swash plate 22 and the motor swash plate anchor 23 which are put into contact with each other are formed in a spherical surface having a center at an intersection of the axis of the motor cylinder 17 and a trunnion axis O2. Further, the motor swash plate 22 is supported by the motor swash plate anchor 23 such that it can relatively rotate around the trunnion axis O2.

A cylindrical cylinder holder 24 is connected to the motor cylinder side end of the motor swash plate anchor 23 and a ball bearing 25 is interposed between the cylinder holder 24 and the outer periphery of the motor cylinder 17.

The motor swash plate 22 is moved between a vertical position at right angles and a maximum tilt position tilted at a predetermined angle with respect to the axis of the motor cylinder 17 when the motor swash plate 22 is rotated around the trunnion axis O2 by a ball screw mechanism 79 connected to a motor 80, and when it is tilted, it can reciprocate the motor plungers 19 to make them repeat a suction stroke and a discharge stroke as the motor cylinder 17 is rotated.

The pump cylinder 7 and the motor cylinder 17 are integrally combined with each other to form a cylinder block B which is integrally formed with an output shaft 31.

One side of the output shaft 31 extends beyond the boundary of the cylinder block B and passes through the plate 10 and the pump swash plate 12 to support the end portion of the pump swash plate 12 via the angular contact ball bearing 33. Further, a ball bearing 35 is disposed between the pump swash plate 12 and the casing 4.

The other side of the output shaft 31 extends beyond the boundary of the cylinder block B and passes through the plate 20, the motor swash plate 22, and the motor swash plate anchor 23. The motor swash plate anchor 23 is supported by the output shaft 31 at end side of the output shaft 31 (at the right end side in FIG. 1) via an angular contact ball bearing 41. The motor swash plate anchor 23 is integrally formed with the casing 4. An input gear 3a of a second speed reduction gear is mounted on the outer periphery of the output shaft 31 at the outside in the axial direction of the output shaft 31.

The inside of the hollow output shaft 31 integral with the cylinder block B forms an oil supply passage 47. The oil supply passage 47 is connected to an oil reservoir 87 at one end of the output shaft 31 (at the left end side in FIG. 1) via an oil filter 89 and an oil supply pump 88. At the other end of the output shaft 31, the oil supply passage 47 is closed with a plug 48 or is opened with a restrictor.

An annular groove is formed on the outer peripheral surface of the output shaft 31 between the group of cylinder bores 8 of the pump cylinder 7 and the group of cylinder bores 18 of the motor cylinder 17 to form an annular inside oil passage 52 between the outer peripheral surface of the output shaft 31 and the inner peripheral surface of the cylinder block B integrally fitted on the output shaft 31. Further, an annular groove is formed on the outer peripheral surface of the cylinder block B to form an annular outside oil passage 53 between the outer peripheral surface of the cylinder block B and the inner peripheral surface of a ring body 56 integrally fitted on the outer peripheral surface of the cylinder block B.

First valve bores 57 are radially made in the annular partition wall between the inside oil passage 52 and the outside oil passage 53 of the cylinder block B, at the group of the cylinder bores 8 side, between the group of cylinder bores 8 of the pump cylinder 7 and the group of cylinder bores 18 of the motor cylinder 17 and in the outer peripheral wall of the outside oil passage 53, that is, in the ring body 56, wherein the number of the first valve bores are equal to that of the cylinder bores 8. Also, second valve bores 58 are radially made in the annular partition wall between the inside oil passage 52 and the outside oil passage 53 of the cylinder block B, at the group of the cylinder bores 18 side, between the group of cylinder bores 8 of the pump cylinder 7 and the group of cylinder bores 18 of the motor cylinder 17 and in the outer peripheral wall of the outside oil passage 53, that is, in the ring body 56, wherein the number of the second valve bores are equal to that of the cylinder bores 18. The respective cylinder bores 8 communicate with the respective first valve bores 57 through respective pump ports 59 and the respective cylinder bores 18 communicate with the respective second valve bores 58 through respective motor ports 60.

Spool type first distributor valves 61 are slidably fitted in the respective first valve bores 57 and spool type second distributor valves 62 are slidably fitted in the second valve bores 58. Then, a first eccentric ring (eccentric cam) 63 surrounding the first distributor valves 61 is engaged with the outside ends of the first distributor valves 61 via a slip ring (or a ball bearing) 65 and a second eccentric ring (eccentric cam) 64 surrounding the second distributor valves 62 is engaged with the outside ends of the second distributor valves 62 via a slip ring (or a ball bearing) 66.

The outside ends of the first distributor valves 61 are combined with each other by a first expansion ring 67 concentric with the first eccentric ring 63 and the outside ends of the second distributor valves 62 are combined with each other by a second expansion ring 68 concentric with the second eccentric ring 64.

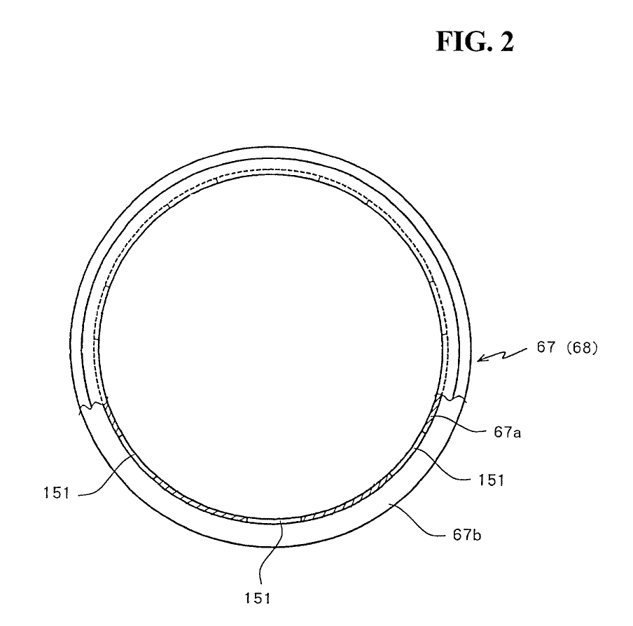

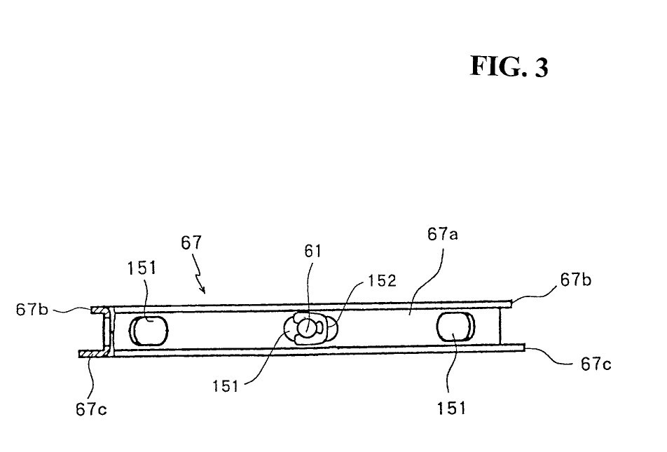

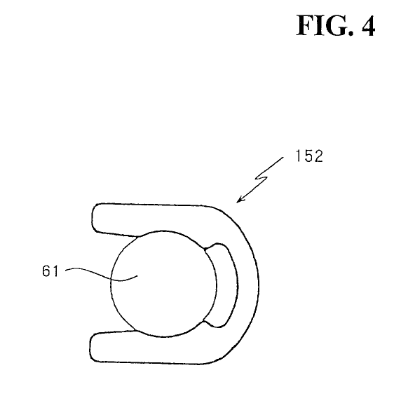

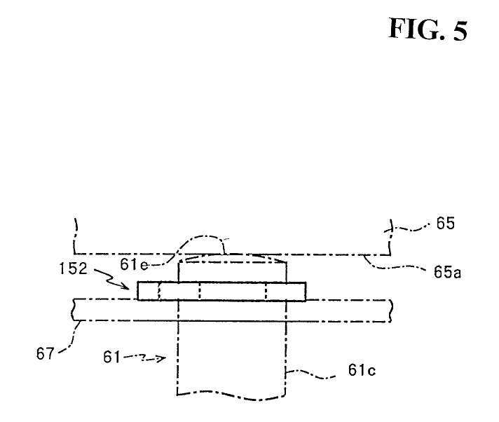

In FIG. 2 is illustrated a side view, partly in cross section, of the first or second expansion ring 67 or 68, and in FIG. 3 is shown a plan view thereof, and in FIG. 4 and FIG. 5 are shown the plan view and the side view of a U-shaped clip. The shape of the first expansion ring 67 is almost the same as that of the second expansion ring 68. Thus, the shape of the first expansion ring 67 will be described as follows.

The first expansion ring 67 is shaped like a ring and includes a sleeve portion 67a and flange portions 67b, 67c formed at both ends thereof with a groove shaped like a letter C in cross section. In the sleeve portion 67a, at equal intervals, are formed as many elongated holes 151 as there are the first distributor valves 61. The elongated hole 151 has a simple shape in which two semicircular portions of the same diameter are connected with straight portions.

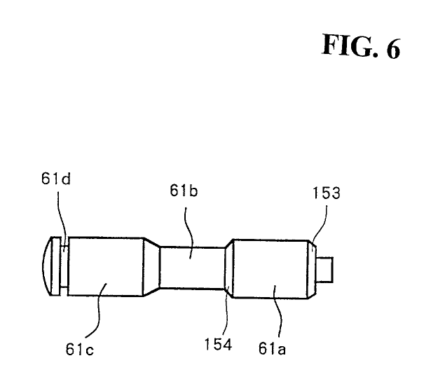

On the other hand, the first distributor valve 61 which is shaped like a spool, as shown in FIG. 6, includes a switching portion 61a for switching the cylinder bore 8 between the low pressure oil passage 52 side and the high pressure oil passage 53 side, a small diameter portion 61b is connected to the switching portion 61a to form an oil passage for introducing hydraulic oil, and a guide portion 61c is connected to the small diameter portion 61b. The tip of the guide portion 61c is a head portion on which an annular groove (cutaway portion) 61d is formed. The switching portion 61a and the guide portion 61c are slidably fitted in the first valve bore 57.

In the groove 61d made on the head portion of the first distributor valve 61 is fitted a U-shaped clip 152 shown in FIG. 4 and FIG. 5 and the first distributor valve 61 is inserted in this state into the elongated hole 151 of the expansion ring 67. Needless to say, the switching portion 61a, the small-diameter portion 61b, the guide portion 61c of the first distributor valve 61 are inserted into the first valve bore 57 of the cylinder block B. When the first distributor valves 61 with clips are inserted into all the elongated holes 151 and the first valve bores 57, they are covered with a slip ring 65 on the outsides thereof and are set in this state inside the first eccentric ring 63 to bring about a state shown in FIG. 1, that is, a state in which the U-shaped clip 152 is engaged with the surface of the sleeve portion 67a of the expansion ring 67 and at the same time the top head surface 61e of the first distributor valve 61 is in contact with the inner peripheral surface 65a of the slip ring 65. Therefore, the first distributor valve 61 is pulled up by the expansion ring 67 via the U-shaped clip 152 and the head portion thereof is pressed down by the slip ring 65.

The second distributor valve 62 and the second expansion ring 68 for holding it have the same structure as the first distributor valve 61 and the first expansion ring 67 and are assembled inside the second eccentric ring 64 in the same way.

The first eccentric ring 63 is integrally formed with the input cylindrical shaft 5 and is positioned eccentrically by a predetermined distance ε1 from the center of the cylinder block B along the tilt center (imaginary trunnion axis O1) of the pump swash plate 12. Also, the second eccentric ring 64 is connected to the cylinder holder 24 and is positioned eccentrically by a predetermined distance ε2 from the center of the cylinder block B along the tilt center (imaginary trunnion axis O2) of the motor swash plate 20.

Here, describing the action of the first distributor valve 61, when a relative rotation is produced between the input cylindrical shaft 5 and the pump cylinder 7, that is, the cylinder block B, the respective first distributor valves 61 are reciprocated by the first eccentric ring 63 between the inside positions and the outside positions in the radial direction of the pump cylinder 7 with a stroke of two times the amount of eccentricity ε1 in the first valve bore 57. In the discharge region of the hydraulic pump P, the first distributor valve 61 is moved to the inside position to make the corresponding pump port 59 communicate with the outside oil passage 53 and to shut the communication between the pump port 59 and the inside oil passage 52, whereby the hydraulic oil is pressure-fed to the outside oil passage 53 from the cylinder bore 8 by the pump plunger 9 in a discharge stroke.

Also, in the suction region of the hydraulic pump P, the first distributor valve 61 is moved to the outside position side to make the corresponding pump port 59 communicate with the inside oil passage 52 and to shut the communication between the pump port 59 and the outside oil passage 53, whereby the hydraulic oil is sucked into the cylinder bore 8 from the inside oil passage 52 by the pump plunger 9 in a suction stroke.

Here, describing the action of the second distributor valve 62, when the motor cylinder 17, that is, the cylinder block B is rotated, the respective second distributor valves 62 are reciprocated by the second eccentric ring 64 between the inside positions and the outside positions in the radial direction of the cylinder block B with a stroke of two times the amount of eccentricity ε2 in the second valve bore 58. In the expansion region of the hydraulic motor M, the second distributor valve 62 is moved to the inside position to make the corresponding motor port 60 communicate with the outside oil passage 53 and to shut the communication between the motor port 60 and the inside oil passage 52, whereby the high pressure hydraulic oil is supplied to the cylinder bore 18 of the motor plunger 19 in an expansion stroke from the outside oil passage 53.

Also, in the contraction region of the hydraulic motor M, the second distributor valve 62 is moved to the outside position side to make the corresponding motor port 60 communicate with the inside oil passage 52 and to shut the communication between the motor port 60 and the outside oil passage 53, whereby the hydraulic oil is discharged into the inside oil passage 52 from the cylinder bore 18 of the motor plunger 19 in a contraction stroke.

In this way, the cylinder block B is rotated by the sum of a reactive torque which is applied to the pump cylinder 7 by the pump swash plate 12 via the pump plunger 9 in the discharge stroke and a reactive torque which is applied to the motor cylinder 17 by the motor swash plate 22 via the motor plunger 19 in the expansion stroke and the rotational torque is transmitted to the second speed reduction gear by the output shaft 31. In this case, the speed change ratio of the output shaft 31 to the input cylindrical shaft 5 is given by the following equation,

Speed change ratio =1+(displacement of hydraulic motor M/ displacement of hydraulic pump P)

Therefore, if the displacement of the hydraulic motor M is changed to a certain value from zero, the speed change ratio can be changed from 1 to a certain necessary value. Further, since the displacement of the hydraulic motor M is determined by the stroke of the motor plunger 19, the speed change ratio can variably be controlled from 1 to a certain value by tilting the motor swash plate 22 from a vertical position to a certain tilt position.

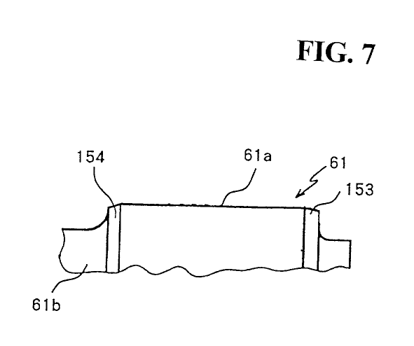

In the present preferred embodiment, as shown in FIG. 7, tapered portions 153, 154 are formed on both the side ends of the switching portion 61a of the first distributor valve 61. The switching portion 61a is a portion for making the pump port 60 communicate with the inside oil passage 52 or the outside oil passage 53 or for shutting the communication between them, and since the communication of the pump port 60 with both the inside oil passage 52 and the outside oil passage 53 results in a reduction in efficiency, the switching portion 61a is required to be longer than the diameter of the pump port 60. When the switching portion 61a communicates with the low pressure oil passage 52 or the high pressure oil passage 53, a rapid change in opening area produces a large change in pressure. Therefore, a change in the opening area can be reduced by forming the tapered portions 153, 154, which can reduce a change in pressure and hence can reduce vibrations and noises. Also, when the first distributor valve 61 slides, it can smoothly move by the guidance of the tapered portions 153, 154. The second distribution valve 62 has the same structure as the first distributor valve 61.

According to the hydrostatic continuously variable transmission in accordance with the present invention, in the hydrostatic continuously variable transmission includes a hydraulic closed circuit in which a swash plate hydraulic pump is connected to a swash plate hydraulic motor with a low pressure oil passage and a high pressure oil passage concentric with the low pressure oil passage. The swash plate hydraulic pump includes valve bores each of which is radially formed to connect the cylinder bore of the hydraulic pump to the low pressure oil passage and the high pressure oil passage. The swash plate hydraulic motor includes valve bores each of which is radially made to connect the cylinder bore of the hydraulic motor to the low pressure oil passage and the high pressure oil passage. Distributor valves are disposed in the valve bores and are moved in a radial direction to switch the cylinder bore of the hydraulic pump and the cylinder bore of the hydraulic motor between the low pressure oil passage and the high pressure oil passage. Expansion rings are provided and the head portion of the distributor valve is inserted into an elongated hole made in the expansion ring and a clip is engaged with a groove made in the head portion of the distributor valve projecting outside from the expansion ring to combine the distributor valve with the expansion ring. Therefore, this can simplify the structure thereof and reduce the weight thereof and does not impair the action of the expansion ring and can reduce manufacturing costs. Further, since the distributor valves have the same diameter, they can be finished by center-through-grinding, which results in ensuring high accuracy and cost reduction.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A hydrostatic continuously variable transmission comprising:
a hydraulic closed circuit having a swash plate hydraulic pump connected to a swash plate hydraulic motor with a low pressure oil passage and a high pressure oil passage concentric with the low pressure oil passage;
said swash plate hydraulic pump having valve bores being radially formed for connecting the cylinder bore of the hydraulic pump to the low pressure oil passage and the high pressure oil passage;
said swash plate hydraulic motor having valve bores being radially formed for connecting the cylinder bore of the hydraulic motor to the low pressure oil passage and the high pressure oil passage; and
distributor valves are disposed in the valve bores and are moved in a radial direction to switch the cylinder bore of the hydraulic pump and the cylinder bore of the hydraulic motor between the low pressure oil passage and the high pressure oil passage;
an expansion ring for mounting said distributor valves relative to the valve bores;
a head portion of the distributor valve being inserted into an elongated hole formed in the expansion ring;
a clip is engaged with a groove formed on the head portion of the distributor valve projecting outside from the expansion ring to combine the distributor valve with the expansion ring.

2. The hydrostatic continuously variable transmission according to claim 1, wherein said expansion ring includes a plurality of elongated holes formed therein for corresponding to the number of distributor valves disposed in the valve bores, each distributor valve being mounted to said expansion ring by individual clips for securing the distributor valve relative thereto.

3. The hydrostatic continuously variable transmission according to claim 1, and further including a slip ring mounted relative to said expansion ring for positioning the distributor valves relative to said expansion ring.

4. The hydrostatic continuously variable transmission according to claim 1, wherein said expansion ring includes a first flange, a second flange and a sleeve, said sleeve being positioned between the first flange and the second flange for forming a substantially C-shaped expansion ring when viewed in cross section.

5. The hydrostatic continuously variable transmission according to claim 4, wherein said elongated hole is formed in the sleeve portion of said expansion ring.

6. The hydrostatic continuously variable transmission according to claim 1, wherein said clip includes a first projecting portion and a second projecting portion, said first and second projecting portions being secured at one end relative to each other and being opened at a distal end for enabling said clip to engage said groove for securing the distributor valve relative to said expansion ring.

7. The hydrostatic continuously variable transmission according to claim 4, and further including a slip ring mounted relative to said expansion ring for positioning the distributor valves relative to said expansion ring, said slip ring being mounted in a spaced apart relationship relative to said sleeve and being disposed between said first and second flanges.

8. The hydrostatic continuously variable transmission according to claim 7, wherein said distributor valve includes a top head surface being in engagement with an inner surface of said slip ring.

9. The hydrostatic continuously variable transmission according to claim 1, and further including a first eccentric ring being positioned relative to said distributor valves mounted within said hydraulic pump for reciprocating said distributor valves as said hydraulic pump is rotated.

10. The hydrostatic continuously variable transmission according to claim 1, and further including a second eccentric ring being positioned relative to said distributor valves mounted within said hydraulic motor for reciprocating said distributor valves as said hydraulic motor is rotated.

11. A hydrostatic continuously variable transmission comprising:
a hydraulic closed circuit having a swash plate hydraulic pump connected to a swash plate hydraulic motor with a low pressure oil passage and a high pressure oil passage concentric with the low pressure oil passage;
said swash plate hydraulic pump having valve bores being radially formed for connecting the cylinder bore of the hydraulic pump to the low pressure oil passage and the high pressure oil passage;
said swash plate hydraulic motor having valve bores being radially formed for connecting the cylinder bore of the hydraulic motor to the low pressure oil passage and the high pressure oil passage; and
distributor valves are disposed in the valve bores and are moved in a radial direction to switch the cylinder bore of the hydraulic pump and the cylinder bore of the hydraulic motor between the low pressure oil passage and the high pressure oil passage;
an expansion ring for mounting said distributor valves relative to the valve bores;
a head portion of the distributor valve being inserted into an elongated hole formed in the expansion ring;
a retainer for securing the distributor valve relative to the expansion ring.

12. The hydrostatic continuously variable transmission according to claim 11, wherein said expansion ring includes a plurality of elongated holes formed therein for corresponding to the number of distributor valves disposed in the valve bores, each distributor valve being mounted to said expansion ring by individual retainers for securing the distributor valve relative thereto.

13. The hydrostatic continuously variable transmission according to claim 11, and further including a slip ring mounted relative to said expansion ring for positioning the distributor valves relative to said expansion ring.

14. The hydrostatic continuously variable transmission according to claim 11, wherein said expansion ring includes a first flange, a second flange and a sleeve, said sleeve being positioned between the first flange and the second flange for forming a substantially C-shaped expansion ring when viewed in cross section.

15. The hydrostatic continuously variable transmission according to claim 14, wherein said elongated hole is formed in the sleeve portion of said expansion ring.

16. The hydrostatic continuously variable transmission according to claim 11, wherein said retainer includes a first projecting portion and a second projecting portion, said first and second projecting portions being secured at one end relative to each other and being opened at a distal end for enabling said retainer to engage said groove for securing the distributor valve relative to said expansion ring.

17. The hydrostatic continuously variable transmission according to claim 14, and further including a slip ring mounted relative to said expansion ring for positioning the distributor valves relative to said expansion ring, said slip ring being mounted in a spaced apart relationship relative to said sleeve and being disposed between said first and second flanges.

18. The hydrostatic continuously variable transmission according to claim 17, wherein said distributor valve includes a top head surface being in engagement with an inner surface of said slip ring.

19. The hydrostatic continuously variable transmission according to claim 11, and further including a first eccentric ring being positioned relative to said distributor valves mounted within said hydraulic pump for reciprocating said distributor valves as said hydraulic pump is rotated.

20. The hydrostatic continuously variable transmission according to claim 11, and further including a second eccentric ring being positioned relative to said distributor valves mounted within said hydraulic motor for reciprocating said distributor valves as said hydraulic motor is rotated.
